(19) United States
(12) Patent Application Publication
(10) Pub. No.: US 2010/0060737 A1
(43) Pub. Date: Mar. 11, 2010

(54) VEHICLE BACK-UP IMAGE SYSTEM

(75) Inventors: HOU-YAO LIN, Tu-Cheng (TW); SHENG-JUNG YU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/551,680

(22) Filed: Sep. 1, 2009

(30) Foreign Application Priority Data
Sep. 5, 2008 (CN) 200810304391.0

(51) Int. Cl. H04N 7/18

(52) U.S. Cl. 348/148; 348/E07.085

(57) ABSTRACT

A vehicle back-up image system includes a holding component, an image assembly, a driving component, a display component and a processing component. The image assembly includes a first camera, a second camera and a holder. The first and second cameras are positioned on the holder. The holder is positioned on the holding component. The driving component is configured to drive the image assembly to rotate with respect to the holding component. The processing component is electrically connected to the driving component and the display component. The processing component is configured to control the driving component to drive the image assembly to rotate, and receive images captured by the first camera or the second camera and deliver the images to the display component.

### BACKGROUND

1. Technical Field

The disclosure relates to an image system, and particularly to an image system used to monitor areas behind a vehicle.

2. Description of Related Art

Many vehicles cannot provide drivers with views of blind spots behind the vehicles, which makes it difficult for the drivers to precisely monitor the rear of a vehicle. To overcome this deficiency, back-up image systems utilizing remote cameras and displays have been incorporated to aid the drivers.

A typical back-up image system includes a camera to monitor the rear view a vehicle. The camera is secured on the middle of a rear portion of the vehicle. In order to provide a wide-angle view, the camera must have a visible angle greater than 150 degrees. As a result, peripheral portions of images captured by the camera are skewed, such that a driver cannot clearly monitor the left and right corners of the rear portion of the vehicle.

Therefore, a new vehicle back-up image system is desired to overcome the above-described shortcoming.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of a first embodiment of a vehicle back-up image system.

FIG. 2 is a perspective view of a second embodiment of a vehicle back-up image system.

### DETAILED DESCRIPTION OF THE EMBODIMENTS

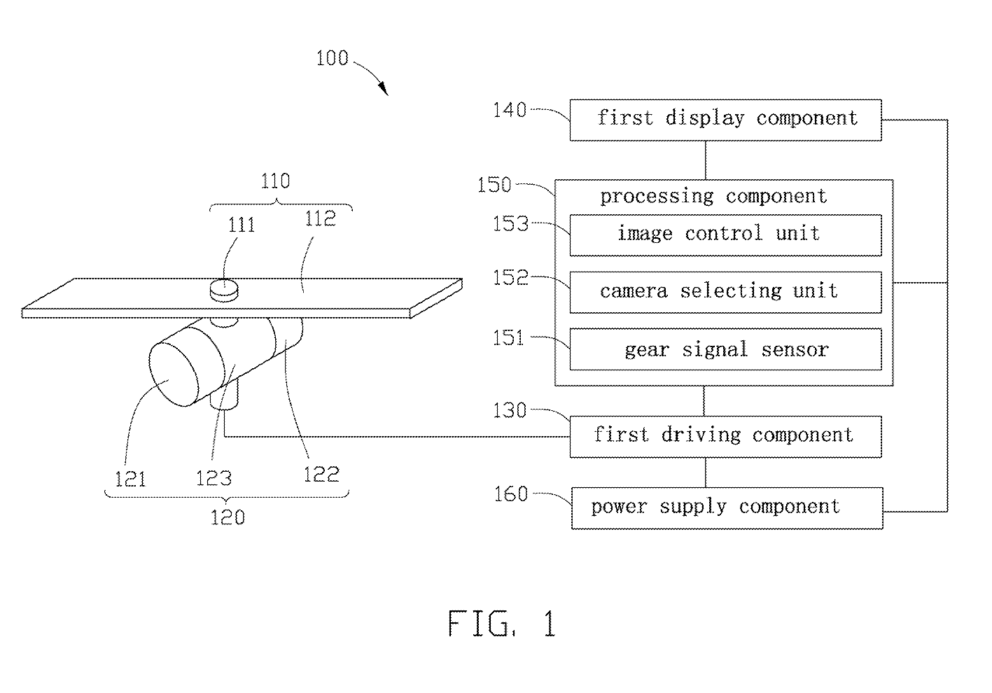

Referring to FIG. 1, a first embodiment of a vehicle back-up image system 100 includes a holding component 110, a first image assembly 120, a first driving component 130, a first display component 140, a processing component 150 and a power supply component 160.

The first image assembly 120 includes a first holder 123, a first camera 121 and a second camera 122. The first and second cameras 121, 122 are positioned on the holder 123. The first camera 121 is configured to capture objects far from a rear portion of a vehicle, and the second camera 122 is configured to capture objects near the rear portion of the vehicle. The first holder 123 is secured on the holding component 110.

The holding component 110 includes a first holding rod 111 and a substrate 112. The first holding rod 111 is perpendicularly positioned on the substrate 112. The first holding rod 111 can rotate with respect to the substrate 112. The first holding rod 111 passes through and holds the first holder 123.

The first driving component 130 is connected to the first holding rod 111 and the processing component 150 and configured to drive the first holding rod 111 to rotate with respect to the substrate 112 instructed by the processing component 150.

The processing component 150 includes a gear signal sensor 151, a camera selecting unit 152 and an image control unit 153. The gear signal sensor 151 is configured to turn on the first and second cameras 121, 122 and the first display component 140 in response to detecting a reverse signal. The camera selecting unit 152 is configured to select between the first camera 121 or the second camera 122. The image control unit 153 is configured to receive images captured by the first camera 121 or the second camera 122 and deliver the images to the display component 140, and to control the first driving component 130. The images can be sent from the first camera 121 or the second camera 122 to the processing component 150 via cables or a wireless network.

The first display component 140 is electrically connected to the processing component 150 and configured to display the images delivered by the processing component 150.

The power supply component 160 is electrically connected to the first driving component 130, the first display component 140 and the processing component 150 and configured to power the first driving component 130, the first display component 140 and the processing component 150.

In uses, the substrate 112 and the first driving component 130 are secured on a rear portion of a vehicle. The display component 140 is positioned inside the vehicle. When the gear sensor 151 detects that the vehicle is in a reverse gear position, the gear signal sensor 151 turns on the first and second cameras 121, 122 and the first display component 140. A driver can use the camera selecting unit 152 to select between the first camera 121 or the second camera 122. The image control unit 153 receives images captured by the first camera 121 or the second camera 122 and delivers the images to the display component 140. The driver can control the first driving component 130 to rotate the first holding rod 111 with respect to the substrate 112 via the image control unit 153. The display component 140 displays the images delivered by the image control unit 153. As a result, the driver can monitor the rear portion of the vehicle via the display component 140.

In one embodiment, the vehicle back-up image system 100 is included inside a vehicle. The substrate 112 and the first driving component 130 are secured on a rear portion of the vehicle. The display component 140 is positioned in the vehicle.

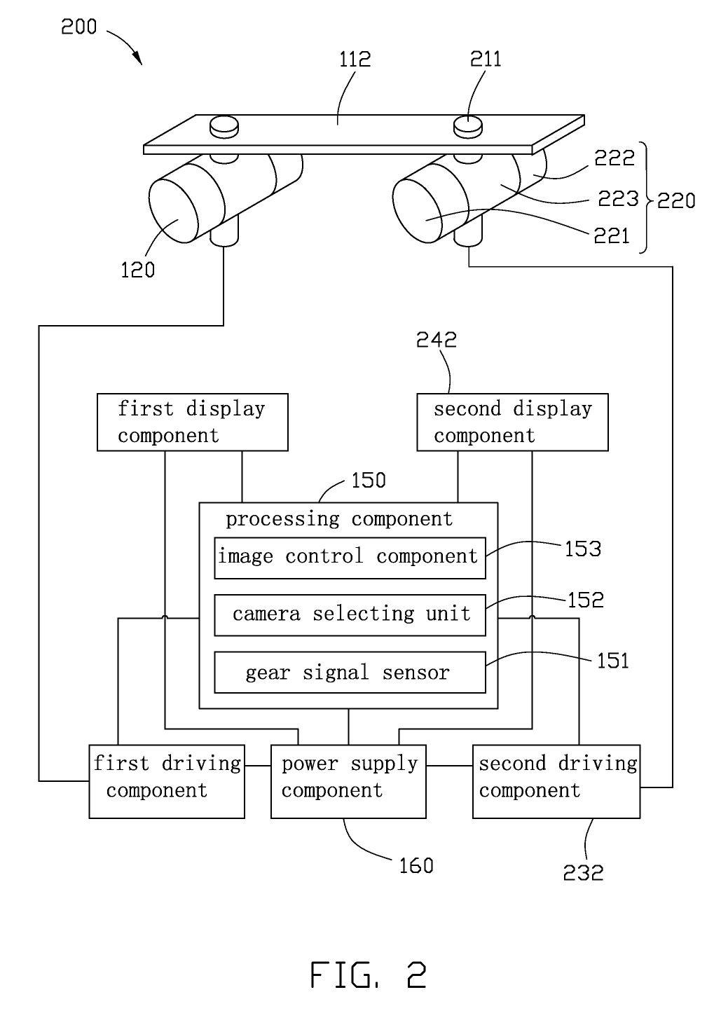

Referring to FIG. 2, a second embodiment of a vehicle back-up image system 200 is similar to the first embodiment of the vehicle back-up image system 100, except that the vehicle back-up image system 200 further includes a second driving component 232, a second display component 242 and a second image assembly 220. The second image assembly 220 includes a second holder 223, a third camera 221 and a fourth camera 222. The third and fourth cameras 221, 222 are positioned on the second holder 223. The third camera 221 is configured to capture objects far from a rear portion of a vehicle, and the fourth camera 222 is configured to capture objects near the rear portion of the vehicle. The second holder 223 is secured on the substrate 112 via a second holding rod 211. The second holding rod 211 is perpendicularly rotatably positioned on the substrate 112. The second holding rod 211 passes through and holds the second holder 223.

The second driving component 232 is connected to the second holder 223 and the processing component 250 and configured to drive the second holding rod 211 to rotate with respect to the substrate 112 instructed by the processing component 150, so as to rotate the third and fourth cameras 221, 222. The second display component 242 is electrically connected to the processing component 150 and configured to display images delivered by the processing component 150. The power supply component 160 is electrically connected to the second driving component 232 and the second display component 242 and configured to power the second driving component 232 and the second display component 242.

It is believed that the present embodiments and their advantages will be understood from the foregoing description, and it will be apparent that various changes may be made thereto without departing from the spirit and scope of the embodiments or sacrificing all of its material advantage.

What is claimed is:

1. A vehicle back-up image system, comprising:
a holding component comprising a substrate and a first holding rod rotatably positioned on the substrate;
a first image assembly comprising a first camera, a second camera, and a first holder, the first and second cameras being positioned on the first holder, and the first holder being positioned on the first holding rod;
a first driving component connected to the first holding rod and configured to drive the first holding rod to rotate with respect to the substrate;
a first display component; and
a processing component electrically connected to the first driving component and the first display component, wherein the processing component is configured to control the first driving component to drive the first holding rod to rotate, and receive images captured by the first camera or the second camera and deliver the images to the first display component.

2. The vehicle back-up image system of claim 1, further comprising a power supply component electrically connected to the first driving component, the processing component and the first display component.

3. The vehicle back-up image system of claim 1, wherein the processing component comprises a gear signal sensor configured to turn on the first camera, the second camera and the display component in response to detecting a reverse signal.

4. The vehicle back-up image system of claim 3, wherein the processing component comprises a camera selecting unit configured to select between the first camera or the second camera.

5. The vehicle back-up image system of claim 4, wherein the processing component comprises an image control unit configured to control the first driving component to drive the first holding rod to rotate, and receive images captured by the first camera or the second camera and deliver the images to the display component.

6. The vehicle back-up image system of claim 1, wherein the first holding is perpendicular to the substrate.

7. The vehicle back-up image system of claim 1, further comprising:
a second display component comprising a second holder, a third camera and a fourth camera, the third and fourth cameras being positioned on the second holder, the second holder being positioned on a second holding rod, and the second holding rod being rotatably positioned on the substrate;
a second driving component electrically connected to the second holding rod and the processing component and configured to drive the second holding rod to rotate; and
a second display component electrically connected to the processing component;
wherein the processing component is configured to control the second driving component to drive the second holding rod to rotate, and receive images captured by the third camera or the fourth camera and deliver the images to the second display component.

8. A vehicle comprising a vehicle back-up image system, the vehicle back-up image system comprising:
a holding component positioned on a rear portion of the vehicle;
a first image assembly comprising a first holder, a first camera and a second camera, the first and second cameras being positioned on the first holder, and the first holder being positioned on the holding component and capable of rotating with respect to the vehicle;
a first driving component configured to drive the first image assembly to rotate;
a first display component; and
a processing component electrically connected to the first driving component and the first display component, wherein the processing component is configured to control the first driving component to drive the first image assembly to rotate, and receive images captured by the first camera or the second camera and deliver the images to the first display component.

9. The vehicle of claim 8, wherein the holding component comprises a substrate and a first holding rod rotatably positioned on the substrate, and the first holder is positioned on the first holding rod.

10. The vehicle of claim 9, wherein the first driving component is connected to the first holding rod.

11. The vehicle of claim 8, further comprising a power supply component electrically connected to the first driving component, the processing component and the first display component.

12. The vehicle of claim 8, wherein the processing component comprises a gear signal sensor configured to detect a reverse signal so as to turn on the first camera, the second camera and the display component.

13. The vehicle of claim 12, wherein the processing component comprises a camera selecting unit configured to select between the first camera or the second camera.

14. The vehicle of claim 13, wherein the processing component comprises an image control unit configured to control the first driving component to drive the first holding rod to rotate, and receive images captured by the first camera or the second camera and deliver the images to the display component.

15. The vehicle of claim 8, wherein the first holding is perpendicular to the substrate.

16. The vehicle of claim 8, further comprising:
a second display component comprising a second holder, a third camera and a fourth camera, the third and fourth cameras being positioned on the second holder, the second holder being positioned on a second holding rod, and the second holding rod being rotatably positioned on the substrate;
a second driving component electrically connected to the second holding rod and the processing component and configured to drive the second holding rod to rotate; and
a second display component electrically connected to the processing component;
wherein the processing component is configured to control the second driving component to drive the second holding rod to rotate, and receive images captured by the third camera or the fourth camera and deliver the images to the second display component.
